(19) United States
(12) Patent Application Publication
(10) Pub. No.: US 2026/0346382 A1
(43) Pub. Date: Nov. 5, 2026

(54) METHOD FOR MANUFACTURING DUCTS FOR A HEAT EXCHANGER

(71) Applicant: SAFRAN NACELLES, Gonfreville-L'Orcher (FR)

(72) Inventors: Pierre Charles Caruel, Moissy-Cramayel (FR); Jean-Charles Michel Pierre Di Giovanni, Moissy-Cramayel (FR); Philippe Bienvenu, Moissy-Cramayel (FR); Pierre-François Behaghel, Moissy-Cramayel (FR); Michel Rognant, Moissy-Cramayel (FR)

(73) Assignee: SAFRAN NACELLES, Gonfreville-L'Orcher (FR)

(21) Appl. No.: 19/099,331

(22) PCT Filed: Jul. 28, 2023
(86) PCT No.: PCT/FR2023/051204

§ 371 Date: Jan. 28, 2025

(30) Foreign Application Priority Data
Aug. 2, 2022 (FR) FR2208021

(51) Int. Cl. B23P 15/26; B21D 53/04; B23K 20/02; B23K 20/18; B23K 101/14

(52) U.S. Cl. CPC B23P 15/26; B21D 53/045; B23K 20/023; B23K 20/18; B23K 2101/14

(57) ABSTRACT

This method for manufacturing a plate comprising ducts for a heat exchanger includes the following steps:—applying an anti-diffusion material to a first metal sheet at places on the first metal sheet that are intended to form duct portions;—placing the first metal sheet in contact with a second metal sheet between a male tool and a female tool forming a mould;—diffusion welding of the first metal sheet to the second metal sheet within the mould in such a way as to form the plate;—injecting a pressurized inert gas between the first metal sheet and the second metal sheet, at the places where the anti-diffusion material has been applied, in order to effect the shaping of the ducts.

### TECHNICAL FIELD

The present invention relates to the manufacture of heat exchangers.

In particular, the present invention relates to the creation of a plate wherein ducts are housed allowing a heat exchange between a heat transfer fluid circulating in the ducts and an external environment.

As a general rule, the invention applies to any type of heat exchanger but is particularly relevant in the context of the manufacture of a heat exchanger disposed on a surface of revolution, and more particularly for an exhaust system of an aircraft turbine engine, the heat exchanger allowing heat recovery in the exhaust flow so as to heat fuel and/or air intended to enter a combustion chamber of the turbine engine.

### PRIOR ART

The manufacture of parts in the aeronautics field is generally subject to mass and size constraints in respect of said parts. In the context of the integration of heat exchangers in an aircraft, and in particular in an aircraft turbine engine, said integration is performed with difficulty after the manufacture of the turbine engine parts and is therefore preferably carried out during the manufacture of said parts.

With a view to enhancing turbine engine performances, it is possible to heat air and/or fuel before they enter a combustion chamber of the turbine engine. A heat source located in the vicinity is preferred so as to increase the thermal efficiency of the turbine engine and thus help reduce the environmental footprint of the turbine engine. A heat source consists for example of the gases outflowing via the exhaust system of the turbine engine.

However, positioning a heat exchanger in the primary exhaust flow of the turbine engine induces turbine engine head losses and negatively impacts the aircraft thrust. Therefore, the positioning of a heat exchanger in the turbine engine must be perfectly integrated so as not to impede the efficiency and the compactness of said turbine engine.

### DISCLOSURE OF THE INVENTION

Therefore, the aim of the present invention is that of manufacturing ducts for a compact and integrated heat exchanger. For this purpose, the invention is the result of technological research aimed at enhancing aircraft performances very significantly and, accordingly, helps reduce the environmental impact of aircraft.

The present invention relates to a method for manufacturing a plate comprising ducts for a heat exchanger, the method comprising the following steps:
Applying an anti-diffusion material to a first metal sheet at places on the first metal sheet intended to form duct portions;
Placing the first metal sheet in contact with a second metal sheet between a male tool and a female tool forming a mold;
Diffusion welding of the first metal sheet to the second metal sheet within the mold in such a way as to form the plate;
Injecting a pressurized inert gas between the first metal sheet and the second metal sheet, at the places where the anti-diffusion material has been applied, in order to effect the shaping of the ducts.

Advantageously, the method comprises a step of injecting a pressurized inert gas into a cavity between one of the first and second metal sheets and one of the male tool and the female tool after the diffusion welding step, so as to shape the first and second metal sheet according to the desired plate shape.

In one implementation, following the step of injecting a gas into a cavity, and before the step of injecting a gas at the places where the anti-diffusion material has been applied, the welded first metal sheet and second metal sheet are positioned in a mold comprising a second male tool and a second female tool.

In another implementation, the welded first metal sheet and second metal sheet are positioned in a mold comprising the male tool and a second female tool, the step of injecting into the cavity being extended and/or repeated so as to be performed simultaneously with the step of injecting a pressurized inert gas between the first metal sheet and the second metal sheet at the places where an anti-diffusion material has been applied, such that the pressure during the inert gas injection is similar in the ducts formed and in the cavity.

Advantageously, the first metal sheet is placed in a contraction of the male tool during the placement step, the contraction having a depth between the thickness of the first metal sheet and the sum of the thicknesses of the first and second metal sheets, and wherein a step of injecting a pressurized inert gas between the second metal sheet and the female tool is performed such that the second metal sheet is partially pushed into the contraction and allows a diffusion welding step without moving the second metal sheet in relation to the first metal sheet.

In one particular implementation, the method further comprises a step of shaping a distributor and/or a manifold between the first metal sheet and the second metal sheet, or between the metal sheet and a third metal sheet.

Advantageously, the method comprises a final step of cooling the metal sheets and a step of sandblasting the metal sheets after shaping the ducts.

Advantageously, the anti-diffusion material comprises boron nitride.

Advantageously, the inert gas comprises argon.

In one implementation, the ducts formed have a cross-section of semi-circular, or rectangular, or bell, or semi-elliptical, or triangular shape.

Advantageously, the metal sheets are made of a material comprising a titanium alloy and/or a nickel alloy.

In one particular implementation, the male tool and the female tool are made in such a way that their expansion coefficients are different.

The invention also relates to an exhaust system comprising a heat exchanger comprising a plate obtained with the method as defined above.

### BRIEF DESCRIPTION OF THE DRAWINGS

Other aims, features and advantages of the invention will appear upon reading the following description, given only as a non-limiting example, and made with reference to the appended drawings wherein:

FIG. 1 is a schematic sectional view of an aircraft turbine engine; and

FIG. 2 is a view of an embodiment of an exhaust system of a turbine engine; and

FIG. 3 is a representation of the different steps of a first implementation of the manufacturing method according to the invention; and

FIG. 4 is a schematic representation of the manufacturing environment for the manufacturing method of FIG. 3; and

FIG. 5A

And

FIG. 5B are schematic sectional representations of a first and a second metal sheets welded during the manufacturing method of FIG. 3; and

FIG. 6 is a representation of the different steps of a second implementation of the manufacturing method according to the invention; and

FIG. 7A

And

FIG. 7B

And

FIG. 7C are schematic sectional representations of a first and a second metal sheets during the manufacturing method of FIG. 6; and

FIG. 8 is a representation of the different steps of a third implementation of the manufacturing method according to the invention; and

FIG. 9A

And

FIG. 9B are schematic sectional representations of a first and a second metal sheets during the manufacturing method of FIG. 8; and

FIG. 10 is a representation of the first steps of the method according to the invention integrating an alternative implementation of said method; and

FIG. 11A

And

FIG. 11B are schematic sectional representations of a first and a second metal sheets during the manufacturing method of FIG. 10; and

FIG. 12 is a representation of an annular male tool and an annular female tool allowing the manufacture of ducts of a heat exchanger in a single sector.

### DETAILED DISCLOSURE OF AT LEAST ONE EMBODIMENT

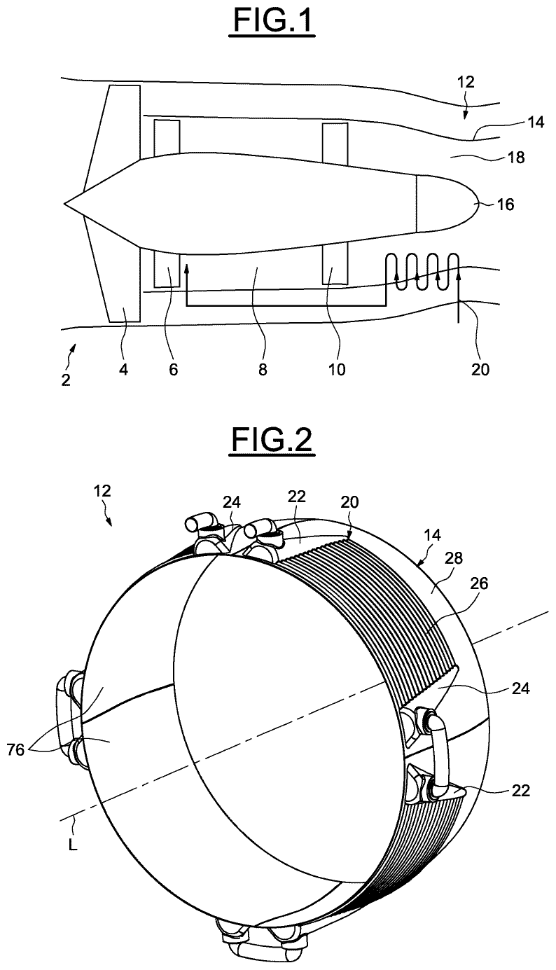

In FIG. 1, an aircraft turbine engine 2 has been represented schematically. The turbine engine 2 comprises a fan 4 for recovering air from the external atmosphere to the turbine engine 2, a compressor 6, a combustion chamber 8, a turbine 10, and an exhaust system 12.

In particular, the exhaust system 12 comprises a nozzle 14 and a central body 16 forming an exhaust gas stream 18 of annular cross-section. The exhaust system 12 comprises a heat exchanger 20 configured to heat fuel at the entry of the combustion chamber 8 and/or air at the exit of the compressor 6 before the entry into the combustion chamber 8 using heat exchanges between the exhaust gas stream 18 and the ducts 26 via the wall of the nozzle 14.

In FIG. 2, an embodiment of the exhaust system wherein the heat exchanger 20 is positioned on the nozzle 14 has been represented schematically. Alternatively, by analogy, the heat exchanger 20 can be positioned on the central body (not shown in FIG. 2) of the exhaust system.

The heat exchanger 20 comprises at least one distributor 22, at least one manifold 24 and ducts 26.

The distributor 22 is configured to inject a heat transfer fluid into the ducts 26 themselves configured to circulate said heat transfer fluid in said ducts 26 to a manifold 24 configured to recover the heated heat transfer fluid.

The ducts 26 are formed in a plate 28 forming the nozzle 14. In the embodiment shown, the nozzle 14 comprises an internal surface in contact with which exhaust gases are expelled.

In particular, the plate 28 comprising the ducts 26 of the heat exchanger 20 is made using the manufacturing method according to the invention described hereinafter.

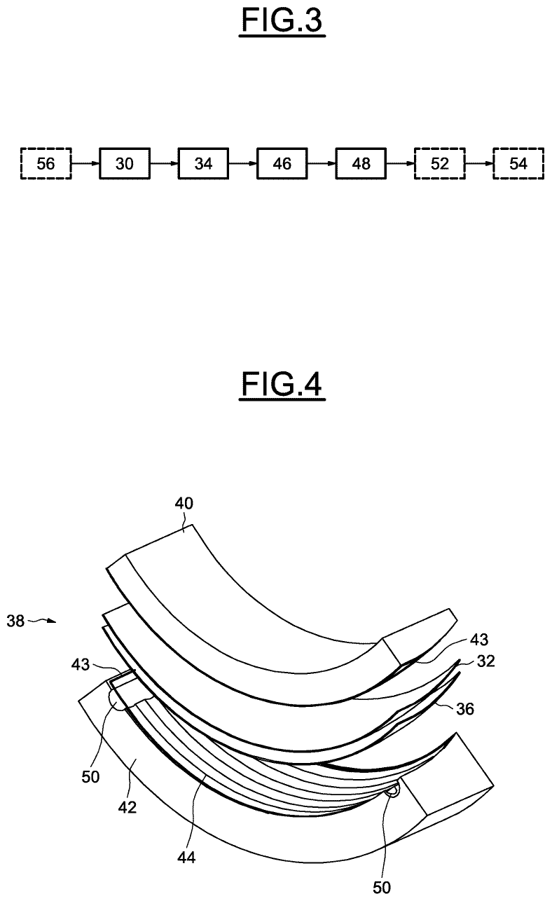

In FIG. 3, the different steps of an implementation of the method for manufacturing a plate 28 comprising ducts 26 according to the invention have been represented. By way of example, reference will be made to the ducts 26 and more broadly to the heat exchanger 20 illustrated in FIG. 2. Nevertheless, other plates 28 of ducts 26 for other purposes can also be made with the implementation of the method hereinafter.

In FIG. 4, a schematic representation of the manufacturing environment of said plate 28 has been represented.

Firstly, a step 30 of applying an anti-diffusion material (not shown) to a first metal sheet 32 at places on the first metal sheet 32 intended to form duct portions 26 is performed. The first metal sheet 32 is for example a planar or curved material fold, the thickness of which is significantly thinner than its other dimensions.

Anti-diffusion material refers to a material which, once applied to the first metal sheet 32, prevents the first metal sheet 32 from being welded to a second metal sheet during diffusion welding. The anti-diffusion material comprises, for example, boron nitride.

In other words, the anti-diffusion material is applied, for example periodically to the first metal sheet 32, so as to form an alternation of anti-diffusion coated metal sheet and uncoated metal sheet. Uncoated metal sheet refers to a portion of metal sheet devoid of an anti-diffusion material coating.

Then, a step 34 of placing the first metal sheet 32 in contact with a second metal sheet 36 is performed. Contact must be established in such a way that the anti-diffusion material is sandwiched between the first metal sheet 32 and the second metal sheet 36.

Furthermore, the first metal sheet 32 and the second metal sheet 36 stacked together are placed in a mold 38 comprising a male tool 40 and a female tool 42 forming said mold 38, the metal sheets 32 and 36 being in particular positioned between the male tool 40 and the female tool 42 illustrated in FIG. 4.

Advantageously, the male 40 and female tools 42 each comprise a seal 43 positioned at the periphery of said tools 40 and 42 at the junction of the male tool 40 and the female tool 42, in order to ensure tightness to fluids between the interior and exterior of the mold 38.

The mold 38 makes it possible to combine specific temperature and pressure conditions, for example conditions required to carry out diffusion welding. The mold 38 is for example comprised in a superplastic forming press. The female tool 42 comprises grooves 44 configured to give the ducts 26 their shape. The male and female tools 40 and 42 have a similar shape to the shape of the metal sheets 32 and 36 such that placing the metal sheets 32 and 36 in the mold 38 does not deform said metal sheets 32 and 36.

The step 46 of diffusion welding of the first metal sheet 32 to the second metal sheet 36 is then performed in the mold 38, the two metal sheets 32 and 36 then becoming integral and forming the plate 28 intended to comprise the ducts 26. Only the places where the anti-diffusion material has been applied do not comprise a weld between the first metal sheet 32 and the second metal sheet 36.

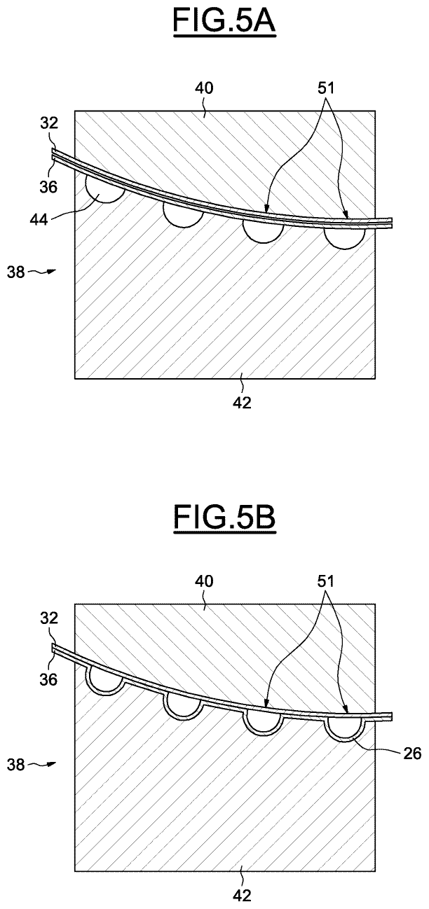

In FIG. 5A, the welded first and second metal sheets 32 and 36 in the mold 38 have been represented schematically.

A step 48 of injecting a pressurized inert gas between the first metal sheet 32 and the second metal sheet 36 is then performed. The injection is performed for example using openings 50 formed in the mold 38, for example in the female tool 42, and illustrated in FIG. 4. The openings 50 are for example configured to form the manifolds 24 and/or the distributors 22. The injected gas is aimed in particular at the places 51 where the anti-diffusion material has been applied. The pressure of the injected gas is configured to deform the second metal sheet 36 and press it against the grooves 44 of the female tool 42 so as to effect the shaping of the ducts 26. The injected inert gas is kept in the mold 38 using the sealing of said mold 38 provided by the seals 43.

In FIG. 5B, the ducts 26 formed following this step 48 of injecting pressurized inert gas have been represented schematically.

Moreover, the inert gas is for example argon or a mixture comprising argon.

Furthermore, the ducts 26 formed take the shape of the grooves 44 which can have different shapes. For example, the cross-section of the ducts formed is of semi-circular, as illustrated, or rectangular, or bell, or semi-elliptical, or triangular shape.

In one implementation, for example for an aeronautics application, the first and second metal sheets 32 and 36 are made of a material resistant to high temperature compared to most metals, for example of a material comprising a titanium alloy and/or a nickel alloy.

In one particular implementation, for example for the manufacture of a heat exchanger 20 as illustrated in FIG. 2, a step (not shown) of shaping a distributor 22 and/or a manifold 24 is performed by injecting an inert gas between the two metal sheets 32 and 36 in a suitable mold. Alternatively, the ducts are formed between the first metal sheet 32 and the second metal sheet 36 and a distributor and/or a manifold is formed between the first metal sheet 32 and a third metal sheet (not shown). The latter implementation makes it possible to form a plate 28 comprising the ducts on one side of the plate, and the distributors and manifolds on the other side of the plate.

Optionally, a step 52 of cooling the metal sheets 32 and 36, and more generally the plate 28 comprising the ducts 26 and formed by welding the metal sheets 32 and 36 is also performed at the end of the manufacturing method. Additionally, a step 54 of stripping the metal sheets 32 and 36, for example by sandblasting, is performed, so as to clean the areas oxidized and/or soiled during the manufacturing method.

In the implementation described above, a step 56 of shaping the first metal sheet and the second metal sheet is performed before the step 30 of applying the anti-diffusion material. The step 56 makes it possible, in the case where the metal sheets 32 and 36 do not have the suitable shape for placing them in the mold 38, to give them the desired plate 28 shape, the mold 38 having a shape also adapted to the desired plate 28 shape.

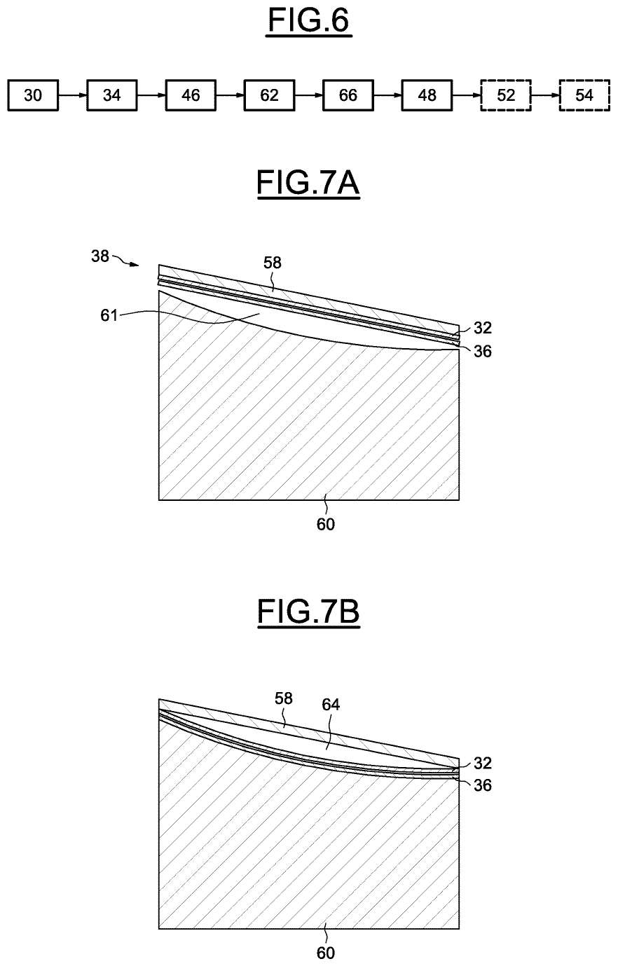

In FIG. 6, the steps of another implementation of the method according to the invention have been represented schematically.

In this implementation, the shaping of the first metal sheet 32 and the second metal sheet 36 is performed during the manufacturing method according to the invention.

The step 30 of applying an anti-diffusion material (not shown) to the first metal sheet 32 at places on the first metal sheet 32 intended to form duct portions 26 is thus performed first. This step is conducted in the same way as the previous implementation illustrated in FIG. 3.

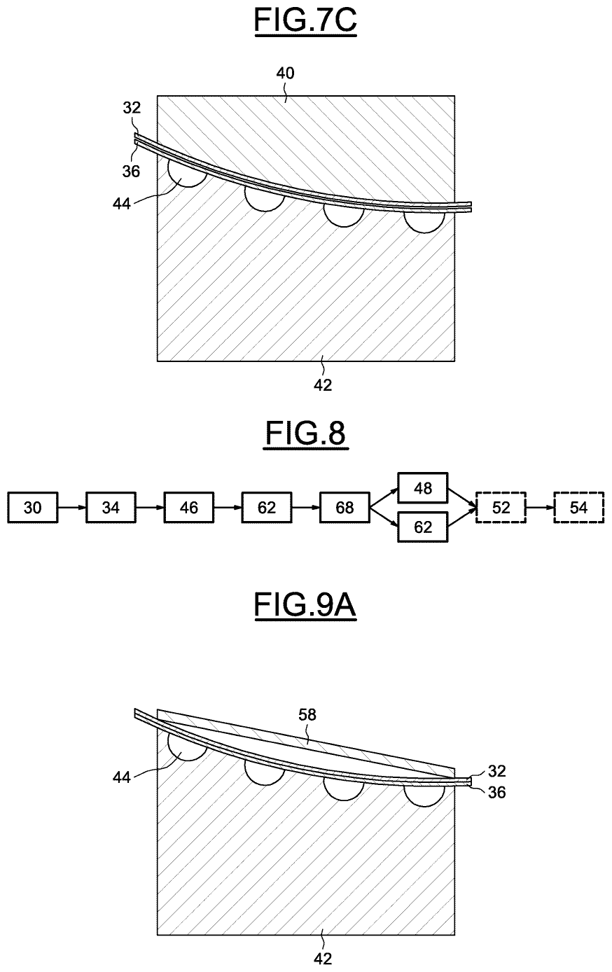

Then, the step 34 of placing the first metal sheet 32 in contact with the second metal sheet 36 is performed as described above. In this implementation, the metal sheets 32 and 36 not being formed beforehand, they are placed in the mold 38 comprising a male tool 58 of neutral shape and a female tool 60 wherein the surface comprises no grooves 44 and corresponding to the desired final plate 28 shape. In FIG. 7A, the first and second metal sheets 32 and 36 between the male tool 58 and the female tool 60 have been represented schematically.

Similarly to the implementation illustrated in FIG. 3, the step 46 of diffusion welding of the first metal sheet 32 to the second metal sheet 36 is then performed in the mold 38, the two metal sheets 32 and 36 then becoming integral and forming the plate 28 intended to comprise the ducts 26. Inert gas is injected into the cavity 61 via the tool 60 to press the first metal sheet 32 and the second metal sheet 36 against the male tool 58 during the diffusion welding. Only the places where the anti-diffusion material has been applied do not comprise a weld between the first metal sheet 32 and the second metal sheet 36.

Then, a step 62 of injecting a pressurized inert gas into a cavity 64 via the tool 58 is performed, for example between the male tool 58 and the first metal sheet 32, so as to give the metal sheets 32 and 36 the desired plate 28 shape. In FIG. 7B, the metal sheets 32 and 36 following this step 62 have been represented.

A step 66 of changing tools in the mold 38 is then performed. The welded metal sheets 32 and 36 are thus positioned between a second male tool 40 and a second female tool 42 identical to the male tool and the female tool of the implementation illustrated in FIG. 3, the welded metal sheets 32 and 36 having the desired final shape. In particular, the female tool 42 comprises grooves 44 configured to give the ducts 26 their shape. In FIG. 7C, the metal sheets 32 and 36 following this step 66 have been represented.

The step 48 of injecting a pressurized inert gas between the first metal sheet 32 and the second metal sheet 36 is then performed as described above, and in order to effect the shaping of the ducts, as illustrated in FIG. 5B.

The steps 62 and 48 of injecting an inert gas are conducted preferably separately, the step 62 of injecting into the cavity 64 being preferably implemented before the step 48 of injecting gas between the metal sheets 32 and 36. Moreover, the injected inert gas can be of the same composition during the implementation of steps 62 and 48, or of different composition.

### Optionally, the steps of cooling 52 and/or stripping 54 are finally performed.

In FIG. 8, the steps of another implementation of the method according to the invention have been represented schematically.

In this implementation, the steps of applying an anti-diffusion material 30, placing the metal sheets 34, diffusion welding 46 and injecting a pressurized inert gas 62 are performed as described in the implementation described above and illustrated in FIG. 6.

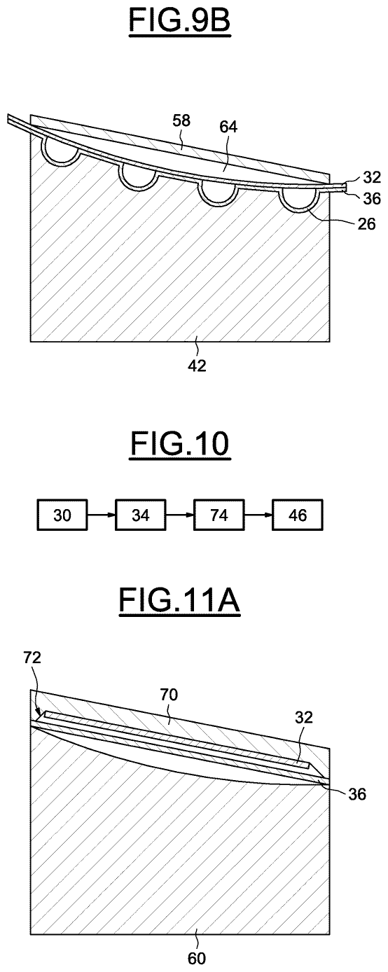

In this implementation, a step 68 of changing a single tool in the mold 38 is however performed. In particular, the welded metal sheets 32 and 36 are thus positioned between the male tool 58 and the second female tool 42 identical to the male tool and the female tool of the implementation illustrated in FIG. 3. In FIG. 9A, the metal sheets 32 and 36 following this step 68 have been represented.

Then, the steps 48 and 62 of injecting pressurized inert gas into the cavity 64 are performed simultaneously, such that the pressure during the inert gas injection is similar in the ducts 26 formed and in the cavity 64 once the plate 28 and the ducts 26 are formed. In FIG. 9B, the metal sheets 32 and 36 following these steps 48 and 62 have been represented.

Optionally, the steps of cooling 52 and/or stripping 54 are finally performed.

In FIG. 10, the first steps of the method according to the invention integrating an alternative implementation of said method have been represented schematically.

In this variant, applicable to all implementations, the step 30 described above of applying an anti-diffusion material is performed, as well as the step 34 of placing the first metal sheet 32 in contact with the second metal sheet 36 as described above.

However, the metal sheets 32 and 36 are positioned between a male tool 70 comprising a contraction 72 and the female tool 60 or 42. More specifically, the first metal sheet 32 is positioned in the contraction 72, the dimensions of the contraction 72 being substantially identical to the dimensions of the first metal sheet 32, as well as less than the dimensions of the second metal sheet 36, the contraction 72 having a depth of a dimension between the thickness of the first metal sheet 32 and the sum of the thicknesses of the first and the second metal sheets 32 and 36.

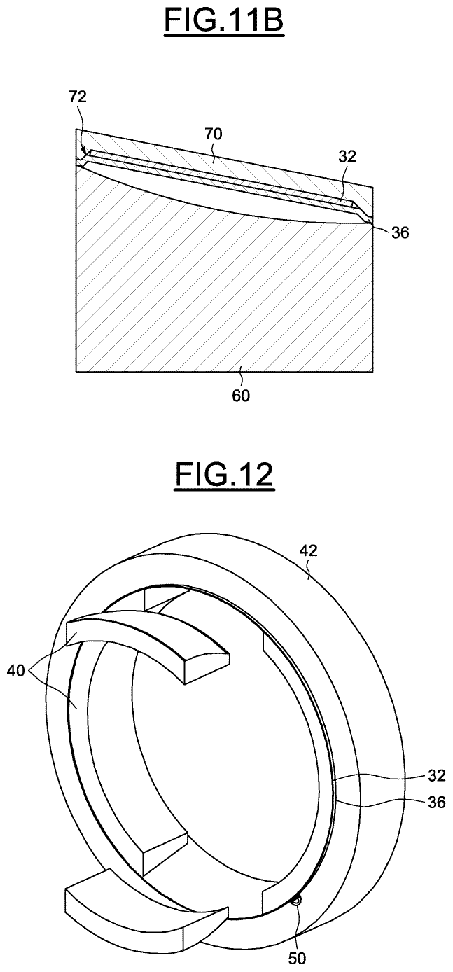

The movements of the first metal sheet 32 are thus limited for the subsequent steps of the method. In FIG. 11A, the metal sheets 32 and 36 following this step 34 have been represented.

Then, a step 74 of injecting a pressurized inert gas between the second metal sheet 36 and the female tool 60 or 42 is performed such that the second metal sheet 36 is partially pushed into the contraction, also limiting the movements of the second metal sheet 36. In FIG. 11B, the metal sheets 32 and 36 following this step 34 have been represented.

The welding step 46 described above is then performed, this step 46 being facilitated by the lack of movement and friction of the second metal sheet 36 in relation to the first metal sheet 32.

The steps following step 46 of the implementations described above and illustrated in FIGS. 3, 6 and 8 can then be performed.

The different implementations described can be implemented for different uses and different heat exchanger shapes.

For the manufacture of ducts for a heat exchanger 20 as illustrated in FIG. 2, it is possible to manufacture different sectors 76, then assemble them, for example by TIG, also known as Tungsten Inert Gas, welding, TIG welding being known to a person skilled in the art.

In FIG. 12, an annular male tool 40 and an annular female tool 42 allowing the manufacture of ducts 26 of a heat exchanger 20 in a single sector according to the implementation of the method illustrated in FIG. 3 have been represented schematically.

Advantageously, the male tool 40 comprises a tool with a key.

Advantageously, the female tool 42 and the male tool are made of materials comprising different expansion coefficients, for example the male tool 40 having a greater extension coefficient than the female tool 42 in order to apply a force more readily on the metal sheets 32 and 36 during the heating for the diffusion welding.

1. A method for manufacturing a plate comprising ducts for a heat exchanger, the method comprising the following steps:
Applying an anti-diffusion material to a first metal sheet at places on the first metal sheet intended to form duct portions;
Placing the first metal sheet in contact with a second metal sheet between a male tool and a female tool forming a mold;
Diffusion welding of the first metal sheet to the second metal sheet within the mold in such a way as to form the plate;
Injecting a pressurized inert gas into a cavity between one of the first and second metal sheets and one of the male tool and the female tool after the diffusion welding step, so as to form the first and second metal sheet according to the desired plate shape; and
Injecting a pressurized inert gas between the first metal sheet and the second metal sheet at the places where the anti-diffusion material has been applied, in order to effect the shaping of the ducts.

2. The method according to claim 1, wherein, following the step of injecting a gas into the cavity, and before the step of injecting a gas at the places where the anti-diffusion material has been applied, the welded first metal sheet and second metal sheet are positioned in a mold comprising a second male tool and a second female tool, or wherein the welded first metal sheet and the second metal sheet are positioned in a mold comprising the male tool and a second female tool, the step of injecting into the cavity being extended and/or repeated so as to be performed simultaneously with the step of injecting a pressurized inert gas between the first metal sheet and the second metal sheet at the places where the anti-diffusion material has been applied, such that the pressure during the inert gas injection is similar in the ducts formed and in the cavity.

3. The method according to claim 1, wherein the first metal sheet is placed in a contraction of the male tool during the placement step, the contraction having a depth between the thickness of the first metal sheet and the sum of the thicknesses of the first and second metal sheets, and wherein a step of injecting a pressurized inert gas between the second metal sheet and the female tool is performed in such a way that the second metal sheet is partially pushed into the contraction and allows a diffusion welding step without moving the second metal sheet in relation to the first metal sheet.

4. The method according to claim 1, further comprising a step of shaping a distributor and/or a manifold between the first metal sheet and the second metal sheet, or between the metal sheet and a third metal sheet.

5. The method according to claim 1, comprising a final step of cooling the metal sheets and a step of sandblasting the metal sheets after shaping the ducts.

6. The method according to claim 1, wherein the anti-diffusion material comprises boron nitride, and/or wherein the inert gas comprises argon.

7. The method according to claim 1, wherein the ducts formed have a cross-section of semi-circular, or rectangular, or bell, or semi-elliptical, or triangular shape.

8. The method according to claim 1, wherein the male tool and the female tool are made of materials of different expansion coefficients.

9. An exhaust system comprising a heat exchanger comprising a plate obtained with the method according to claim 1.
